(19) United States
(12) Patent Application Publication
(10) Pub. No.: US 2002/0124969 A1
(43) Pub. Date: Sep. 12, 2002

(54) ADHESIVE TAPE HOLDER STRUCTURE

(76) Inventor: Rong-Li Hsu, Jen-De Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/799,030

(22) Filed: Mar. 6, 2001

(51) Int. Cl. B44C 7/00

(52) U.S. Cl. 156/577; 156/579

(57) ABSTRACT

An adhesive tape holder structure includes a body, a spool, a first pivot portion provided with a first support portion, a second pivot portion provided with a second support portion, a press roller, a blade receiving portion, a cutting blade. In practice, the position of the first support portion located on the first pivot portion and the position of the second support portion located on the second pivot portion are based on a reference direction seen from a side face of the body. An axis center of the press roller and a middle point of the first support portion or the second support portion forms a first line. The axis center of the press roller and an end point of the cutting blade forms a second line. An included angle between the first line and the second line is smaller than sixty degrees.

### BACKGROUND OF THE INVENTION

1. Field of the Invention

The present invention relates to an adhesive tape holder structure.

2. Description of the Related Prior Art

A conventional adhesive tape holder structure in accordance with the prior art shown in FIGS. 12 and 13 comprises a body 20, a spool 21 for supporting an adhesive tape, two pivot portions 22, a press roller 23, a cutting blade 24, and two support rollers 25. The distal end of adhesive tape in turn passes through the support rollers 25, the press roller 23, and is stuck on one end of the cutting blade 24. In such a manner, the adhesive tape can be bonded on an article to a desired length, and can then be cut by the cutting blade 24.

However, the included angle “Al” between the first line “C” formed by the axis center of the press roller 23 and the middle point of the support roller 25, and the second line “D” formed by the axis center of the press roller 23 and an end point of the cutting blade 24 is too large, often larger than ninety degrees (90°), so that the length of the distal end of the adhesive tape to the support portion is too large when the adhesive tape is cut by the cutting blade. In such a manner, the adhesive tape will easily depend downward, so that the user has to hold the body 20 with his one hand, and hold the distal end of the adhesive tape with his other hand, thereby causing inconvenience in use.

### SUMMARY OF THE INVENTION

The present invention has arisen to mitigate and/or obviate the disadvantage of the conventional adhesive tape holder structure.

In accordance with the present invention, there is provided an adhesive tape holder structure comprising: a body having a first end provided with a spool for supporting an annular adhesive tape, and a second end provided with a first pivot portion and a second pivot portion juxtaposed with each other, a press roller pivotally mounted between the first pivot portion and the second pivot portion by shafts, the first pivot portion having an upper edge connected with an upper edge of the second pivot portion to form a blade receiving portion, a cutting blade secured on the blade receiving portion and having one side formed with teeth and located above the press roller, the first pivot portion provided with a first support portion, the second pivot portion provided with a second support portion, the first support portion and the second support portion extending toward each other, a distance between a distal end of the first support portion and a distal end of the second support portion being smaller than a width of the adhesive tape,

wherein, the position of the first support portion located on the first pivot portion and the position of the second support portion located on the second pivot portion are based on a reference direction seen from a side face of the body, an axis center of the press roller and a middle point of the first support portion or the second support portion forms a first line, the axis center of the press roller and an end point of the cutting blade forms a second line, and an included angle between the first line and the second line is smaller than sixty degrees.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of an adhesive tape holder structure in accordance with the present invention;

FIG. 2 is a perspective assembly view of the adhesive tape holder structure as shown in FIG. 1;

FIG. 3 is a partially enlarged view of the adhesive tape holder structure as shown in FIG. 2;

FIG. 4 is a front plan view of the adhesive tape holder structure as shown in FIG. 2;

FIG. 5 is a top plan view of the adhesive tape holder structure as shown in FIG. 2;

FIG. 6 is a side plan cross-sectional assembly view of the adhesive tape holder structure as shown in FIG. 2;

FIG. 7 is a schematic operational view of the adhesive tape holder structure as shown in FIG. 6 in use;

FIG. 8 is a schematic operational view of the adhesive tape holder structure as shown in FIG. 7 in use;

FIG. 9 is a perspective view of the adhesive tape holder structure in accordance with another embodiment of the present invention;

FIG. 10 is a perspective view of the adhesive tape holder structure in accordance with a further embodiment of the present invention;

FIG. 11 is a side plan cross-sectional view of the adhesive tape holder structure as shown in FIG. 10;

FIG. 12 is a perspective view of a conventional adhesive tape holder structure in accordance with the prior art; and

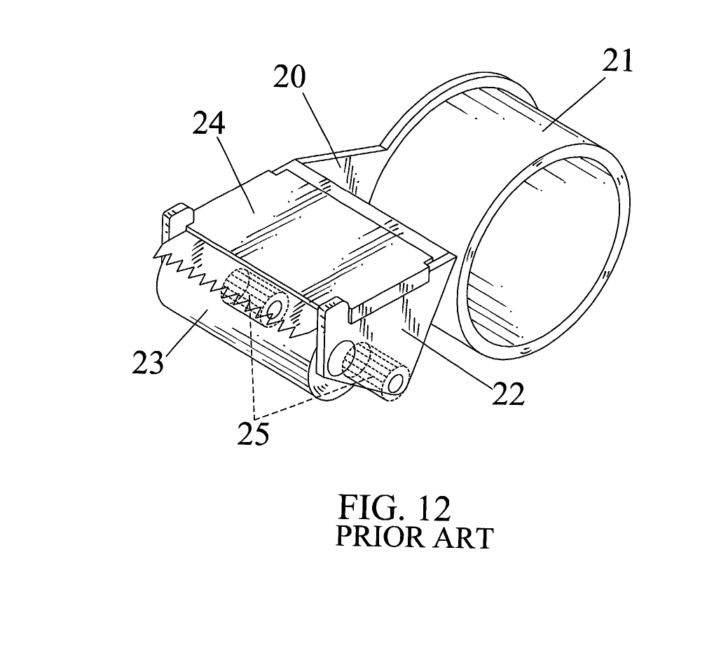

FIG. 13 is a side plan view of the conventional adhesive tape holder structure as shown in FIG. 12.

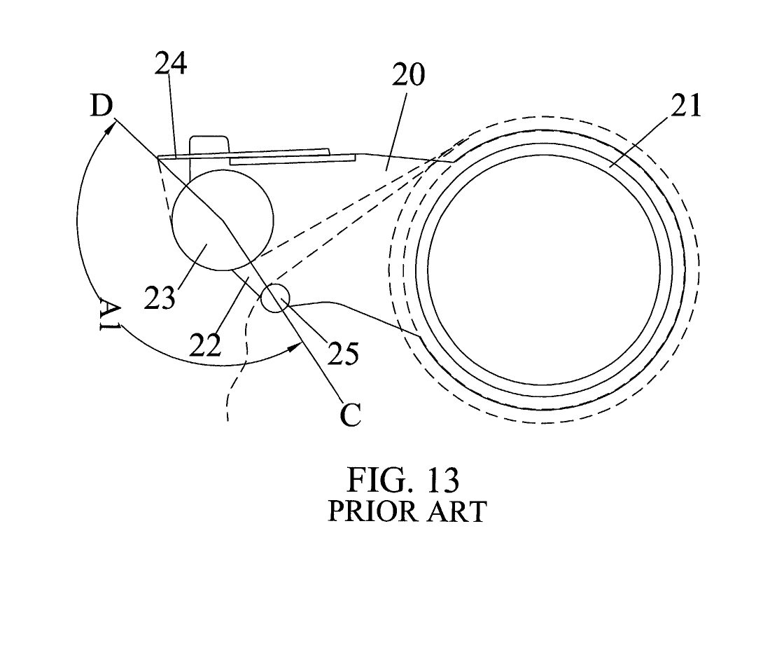

### DETAILED DESCRIPTION OF THE INVENTION

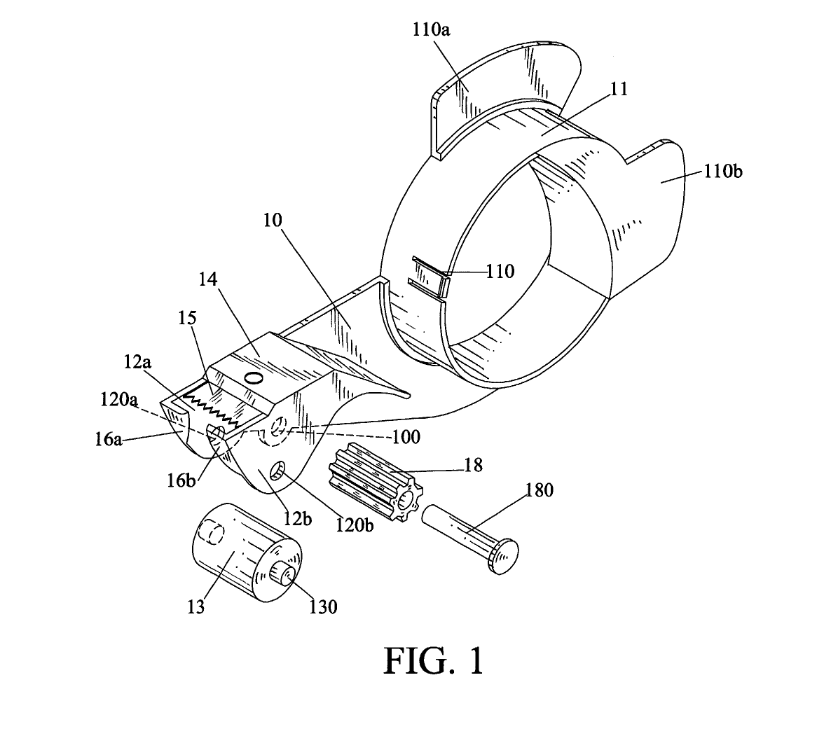

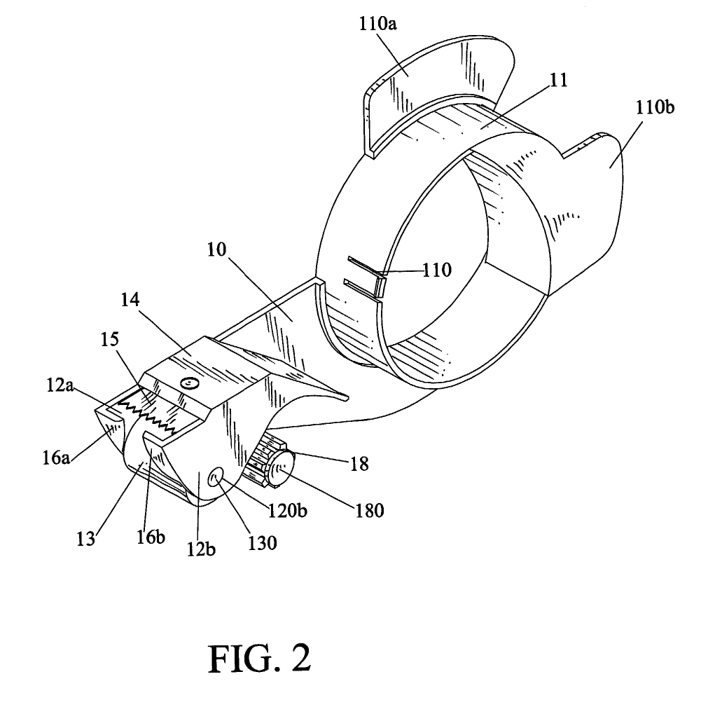

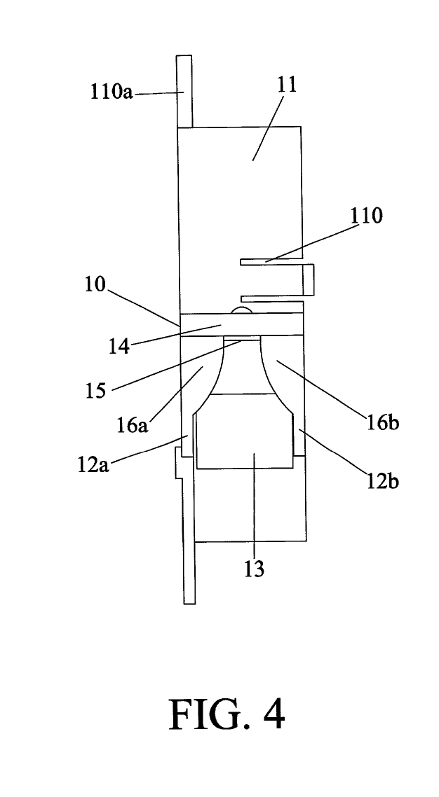

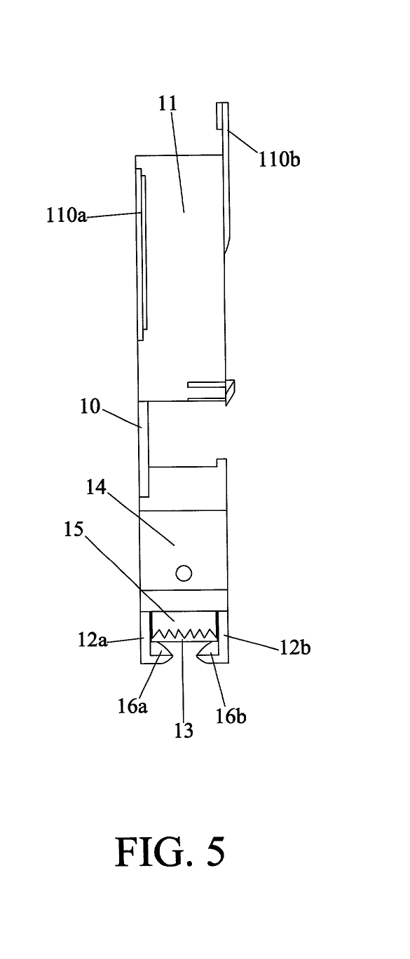

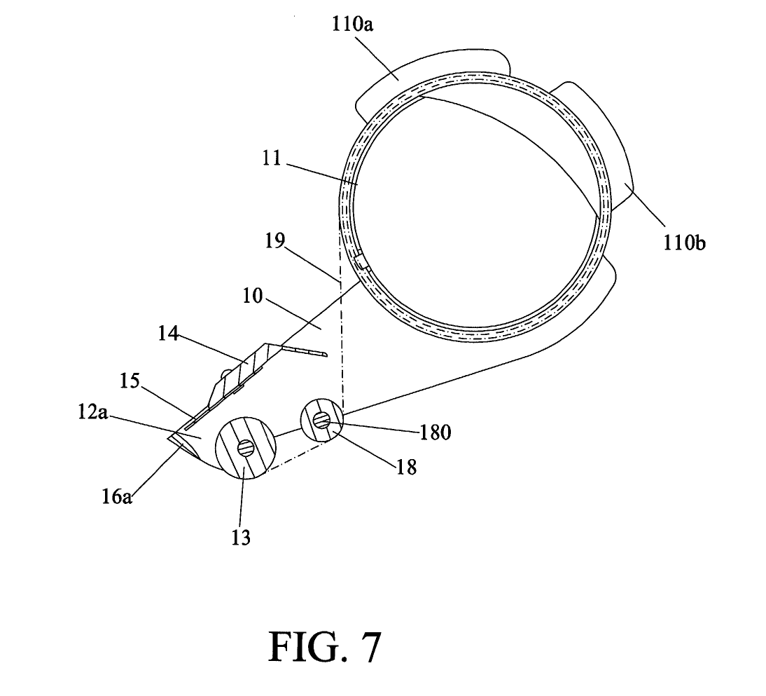

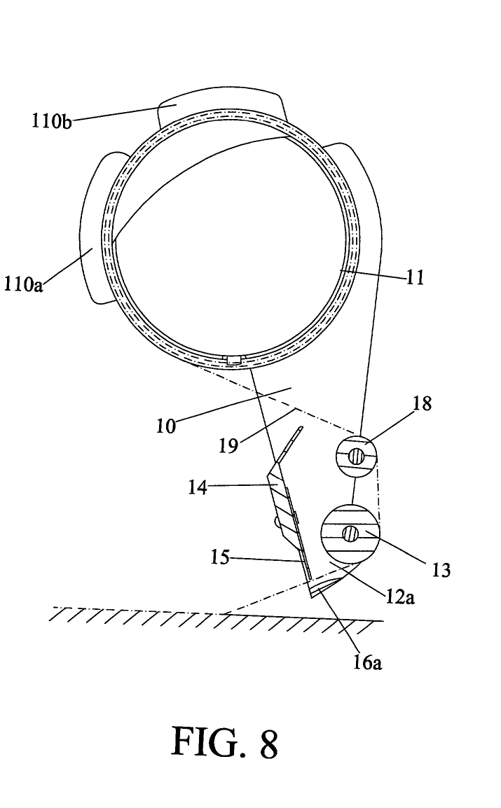

Referring to FIGS. 1-9, an adhesive tape holder structure according to the present invention comprises a body 10 having a first end provided with a spool 11 supporting an annular adhesive tape 19, and a second end provided i1 with a first pivot portion 12a and a second pivot portion 12b juxtaposed with each other. A press roller 13 is pivotally mounted between the first pivot portion 12a and the second pivot portion 12b. The press roller 13 has two sides each provided with a shaft 130 received in a first pivot hole 120a defined in the first pivot portion 12a and a second pivot hole 120b defined in the second pivot portion 12b, so that press roller 13 is pivotally mounted between the first pivot portion 12a and the second pivot portion 12b. The first pivot portion 12a has an upper edge connected with the upper edge of the second pivot portion 12b to form a blade receiving portion 14. A cutting blade 15 is secured on the blade receiving portion 14 and has one side formed with teeth and located above the press roller 13. The first pivot portion 12a is provided with a first support portion 16a, and the second pivot portion 12b is provided with a second support portion 16b. The first support portion 16a and the second support portion 16b extend toward each other. The distance between the distal end of the first support portion 16a and the distal end of the second support portion 16b is smaller than the width of the adhesive tape 19.

The improvement of the present invention will be described as follows.

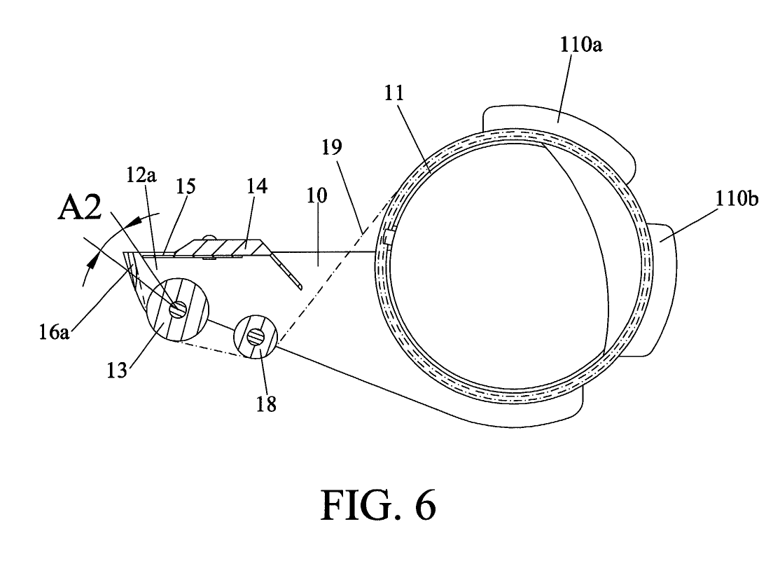

The position of the first support portion 16a located on the first pivot portion 12a and the position of the second support portion 16b located on the second pivot portion 12b are based on a reference direction seen from a side face of the body 10 as shown in FIG. 6.

The axis center of the press roller 13 and the middle point of the first support portion 16a or the second support portion 16b forms a first line. The axis center of the press roller 13 and an end point of the cutting blade 15 forms a second line. The included angle “A2” between the first line and the second line is smaller than sixty degrees (60°).

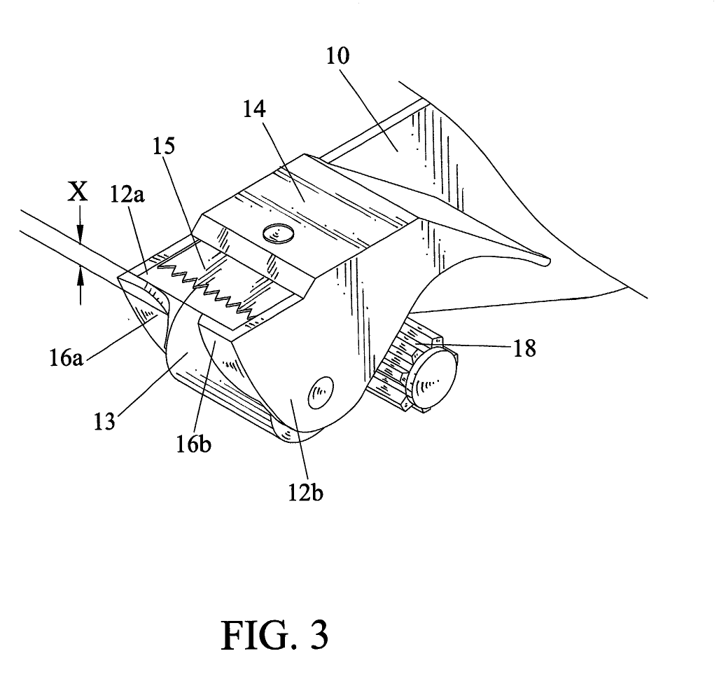

As shown in FIG. 3, the first support portion 16a and the second support portion 16b are arranged in a slightly upper and lower staggered manner, so that the first support portion 16a and the second support portion 16b has a distance “X” defined therebetween. In such a manner, when the adhesive tape 19 enters or leaves the first support portion 16a and the second support portion 16b, the adhesive tape 19 may easily pass through the first support portion 16a and the second support portion 16b.

As shown in FIG. 1, the spool 11 has a tubular shape, and has a periphery defining a plurality of longitudinally extended slits 110. In addition, the spool 11 has an outer circumference provided with a first retaining ear 110a and a second retaining ear 110b arranged in a staggered manner, so that the adhesive tape 19 may be easily fitted onto the spool 11, and thereby efficiently preventing the adhesive tape 19 from detaching from the spool 11.

The adhesive tape holder structure also comprises an intermediate wheel 18 pivotally mounted on the body 10 and located between the press roller 13 and the spool 11. A pin 180 extends through the intermediate wheel 18 and through a pivot hole 100 defined in the body 10 so that the intermediate wheel 18 is pivotally mounted on the body 10.

In operation, a distal end of the adhesive tape 19 wound around the spool 11 in turn passes through the intermediate wheel 18, the press roller 13, and is stuck on the inner face of the first support portion 16a and the second support portion 16b.

As shown in FIGS. 6-8, the press roller 13 may be moved toward an article to adhered, until the distal end of the adhesive tape 19 is bonded on the article, and then a force is applied to pull the press roller 18 backward. At the same time, the distal end of the adhesive tape 19 is only slightly stuck on the inner face of the first support portion 16a and the second support portion 16b, so that when the body 10 is pulled backward, the distal end of the adhesive tape 19 will detach from the first support portion 16a and the second support portion 16b, so that the adhesive tape 19 is continuously extended outward to bond along the surface of the article until the required length is reached.

Then, the first end of the body 10 with the spool 11 is rotated upward so that the adhesive tape 19 will pass through the first support portion 16a and the second support portion 16b to enter the inner face of the first support portion 16a and the second support portion 16b. Meanwhile, the adhesive tape 19 is cut by the cutting blade 15, while the cut distal end of the adhesive tape 19 is again stuck on the inner face of the first support portion 16a and the second support portion 16b, and will not depend downward.

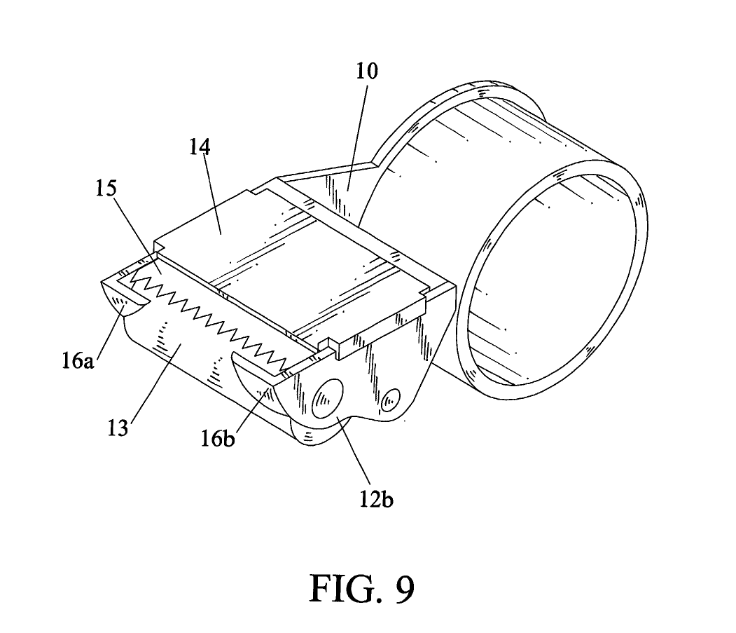

As shown in FIG. 9, the adhesive tape holder structure in accordance with another embodiment of the present invention is shown.

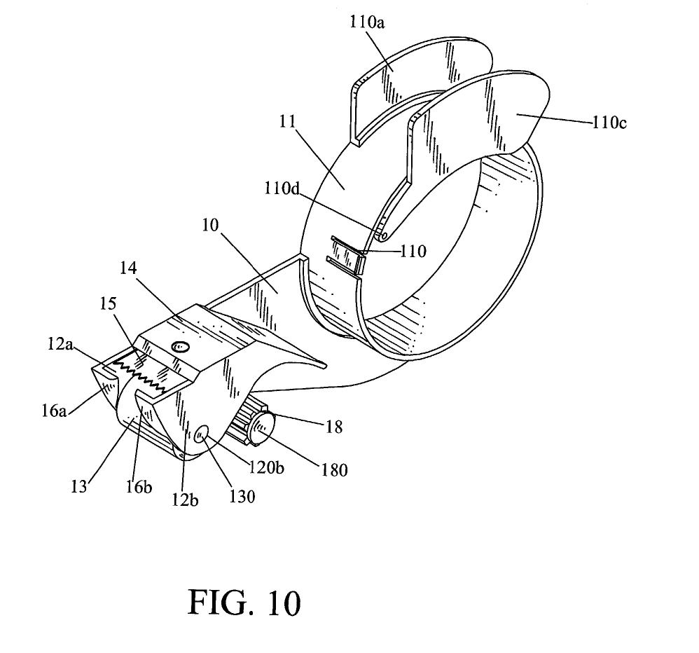

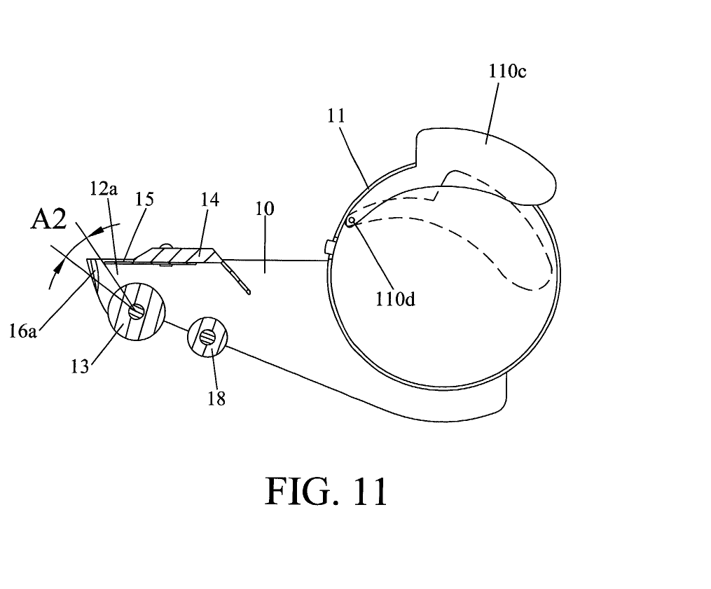

Referring now to FIGS. 10 and 11, in accordance with a further embodiment of the present invention, a pivot ear 110c is pivoted on the spool 11 about a pivot 110d. the pivot ear 110c is lowered during installation of the adhesive tape, and is lifted in use, thereby preventing the user's hand from pressing the adhesive tape to hinder rotation of the adhesive tape.

Accordingly, the adhesive tape holder structure in accordance with the present invention will achieve the following advantage. The included angle between the first line formed by the axis center of the press roller and the middle point of the support portion, and the second line formed by the axis center of the press roller and an end point of the cutting blade is smaller than sixty degrees (60°), so that the length of the distal end of the adhesive tape to the support portion is greatly reduced when the adhesive tape is cut by the cutting blade. In such a manner, the adhesive tape will not depend downward, so that the user may conveniently operate the adhesive tape holder structure by one hand only.

In addition, the user can operate the adhesive tape by his single hand, so that the adhesive tape will not stick to the user's hand, and the user's fingerprint will not be left on the adhesive tape.

Further, the user's finger or the paper will not be cut by the cutting blade 15 by protection of the first support portion 16a and the second support portion 16b.

Further, the adhesive tape is directly rolled on the article to be adhered and cut, without having to previously measure the length to be cut.

Although the invention has been explained in relation to its preferred embodiment as mentioned above, it is to be understood that many other possible modifications and variations can be made without departing from the scope of the present invention. It is, therefore, contemplated that the appended claims will cover such modifications and variations that fall within the true scope of the invention.

What is claimed is:

1. An adhesive tape holder structure comprising: a body (10) having a first end provided with a spool (11) for supporting an annular adhesive tape (19), and a second end provided with a first pivot portion (12a) and a second pivot portion (12b) juxtaposed with each other, a press roller (13) pivotally mounted between said first pivot portion (12a) and said second pivot portion (12b) by shafts (130), said first pivot portion (12a) having an upper edge connected with an upper edge of said second pivot portion (12b) to form a blade receiving portion (14), a cutting blade (15) secured on said blade receiving portion (14) and having one side formed with teeth and located above said press roller (13), said first pivot portion (12a) provided with a first support portion (16a), said second pivot portion (12b) provided with a second support portion (16b), said first support portion (16a) and said second support portion (16b) extending toward each other, a distance between a distal end of said first support portion (16a) and a distal end of said second support portion (16b) being smaller than a width of said adhesive tape (19),
wherein, the position of said first support portion (16a) located on said first pivot portion (12a) and the position of said second support portion (16b) located on said second pivot portion (12b) are based on a reference direction seen from a side face of said body (10), an axis center of said press roller (13) and a middle point of said first support portion (16a) or said second support portion (16b) forms a first line, said axis center of said press roller (13) and an end point of said cutting blade (15) forms a second line, and an included 9 angle between said first line and said second line is smaller than sixty degrees (60°).

2. The adhesive tape holder structure in accordance with claim 1, wherein said first support portion (16a) and said second support portion (16b) are arranged in a slightly upper and lower staggered manner, so that said first support portion (16a) and said second support portion (16b) has a distance (X).

3. The adhesive tape holder structure in accordance with claim 1, wherein said spool (11) has a tubular shape, and has a periphery defining a plurality of longitudinally extended slits (110).

4. The adhesive tape holder structure in accordance with claim 3, wherein said spool (11) has an outer circumference provided with a first retaining ear (110a) and a second retaining ear (110b) arranged in a staggered manner.

5. The adhesive tape holder structure in accordance with claim 1, further comprising an intermediate wheel (18) pivotally mounted on said body (10) and located between said press roller (13) and said spool (11).

6. The adhesive tape holder structure in accordance with claim 1, further comprising a pivot ear (110c) pivoted on said spool (11) about a pivot (11Od).
